(19) United States
(12) Patent Application Publication
(10) Pub. No.: US 2008/0112857 A1
(43) Pub. Date: May 15, 2008

(54) VAPOR DELIVERING DEVICE

(75) Inventors: Melodie A. McKenzie-Jones, Birmingham (GB); Christopher J.N. Clews, Warley (GB); David W. Paddock, Cannock (GB)

Correspondence Address: LAW OFFICES OF RONALD M ANDERSON, 600 108TH AVE, NE, SUITE 507, BELLEVUE, WA, 98004, US

(73) Assignee: Vapourised Lighting Limited, Birmingham (GB)

(21) Appl. No.: 11/686,687

(22) Filed: Mar. 15, 2007

(30) Foreign Application Priority Data
Nov. 10, 2006 (GB) GB 0622418.2

(51) Int. Cl. A01M 1/20

(52) U.S. Cl. 422/125; 362/101

(57) ABSTRACT

An apparatus is disclosed for delivering vaporized chemicals into the atmosphere. In one embodiment the device comprises a light bulb with a glass casing and a region of sintered glass. Alternative embodiments are disclosed in which the device comprises a retainer adapted to retain chemical carrying elements and fixing means adapted to secure the retainer to a heat source. The chemical carrying element is sintered glass. The sintered glass preferably has a homogenous particle distribution and may be nanoporous.

### RELATED APPLICATIONS

This application is based on a prior, copending foreign application, GB 0622418.2, filed in Great Britain on Nov. 10, 2006, the benefit of the filing date of which is hereby claimed under 35 U.S.C. §119(a)-(d) and (f).

### BACKGROUND

This invention relates to an improved vapor delivering device, especially suited to the evaporation of oils and the like into the atmosphere.

It is well known to provide vapor delivering devices around the home or work environment. The devices deliver a vapor which is preferably fragranced to the surrounding air which may help in masking unwanted odors. Some fragrances have also been shown to help induce a feeling of well being to anyone inhaling the fragrance. Such devices may also be used to deliver non-fragranced vapors such as insecticides.

Traditionally, air fresheners have been in the form of stand-alone devices containing fragrant oil or the like. They have the advantage that they can be placed anywhere around the home or work, such as on a desk or windowsill. This can, however, be inconvenient and not all designs are pleasing to the eye.

An alternative, improved design, comprises a device which includes an electric heating element that can be plugged into a wall socket in a room. The electric heating element receives current from the supply to the socket which warms it up, in turn warming a pot of fragranced oil. Switching the device on or off allows the user to control the rate of evaporation of the oil and hence the fragrance. A disadvantage of such devices is that sockets around the home are often in inconvenient positions, for example behind a sofa or television, or may all be in use with other appliances.

It is also known to utilize vapor delivering devices to vaporize insect deterrents or insecticides.

### SUMMARY

It is an object of the present invention to provide an alternative vapor delivering device.

According to a first aspect the invention provides a vapor delivering device for the evaporation of chemicals into the atmosphere by thermal diffusion the device comprising:
a light bulb having a fitting suitable for connection to a light socket said light bulb comprising:
a light emitting element;
a casing, said casing having a portion that is partially transparent;
said casing surrounding said light emitting element to permit light to pass through said partially transparent portion;
said casing being made of glass and including at least one region of sintered glass;
said sintered glass region being adapted to hold a volatile substance; and
whereby in use said light emitting element emits heat which heats said sintered glass region causing at least some of the substance to evaporate.

Providing a device in the form of a bulb reduces the need for either a separate device or a free wall socket.

The volatile substance may comprise an oil based substance, which may be scented to release fragrance into the atmosphere. For example it may contain menthol.

Alternatively or additionally the volatile substance may be a deodorizing substance, an insecticide, a bactericidal preparation, a fungicide or some other chemical substance. It may be a therapeutic preparation such as an asthmatic.

Providing a chemical holding layer of sintered glass which is integral with the glass casing of the bulb provides a device which looks very similar to an ordinary bulb as well as being robust and simple to manufacture.

The light bulb may have an incandescent light emitting element and may have either a bayonet type or screw cap type fitting. This allows the device of the invention to be used in place of a conventional light bulb in a lamp or pendant fitting, a wall light or ceiling light or the like. It will be understood that this list is not intended to be limiting.

The sintered glass layer may be fused or bonded to the glass casing. It is preferably fused by being applied to the glass casing when the bulb is formed, perhaps before the molten glass used to form the casing has fully cooled. However it is applied, it is preferred that the sintered glass forms an integral part of the casing. The sintered glass layer is preferably at least partially transparent.

The sintered glass layer may alternatively be fixed to the glass bulb by a coupling which is itself secured to the bulb. The coupling may comprise a pin which may pass through the glass casing. The pin may carry a thread which protrudes from the glass casing and which co-operates with a complimentary thread on the sintered glass layer. This arrangement may be advantageous as it allows the sintered layer to be detached from the glass casing.

The thread may be a universal twist lock fastening. In this arrangement the glass layer may be preshaped to compliment the shape of the glass casing onto which it is to be fitted.

The sintered glass layer may be applied around a portion of the bulb furthest from the fitting. In this way the sintered glass will be at the top of the bulb when it is fitted to most standard table or desk or floor standing lamps. This allows the fragrance to evaporate straight upwards as the bulb warms up, being circulated around a surrounding area by convection.

In one arrangement, a pin of thermally conductive material may be provided within the layer which extends from inside of the bulb casing outwards through the sintered layer. Alternatively, it may extend from a point in on touching the casing through the sintered layer. The pin may help carry heat through the layer to ensure optimum temperatures in the layer for controlled evaporation.

The pin may be metal, for example molybdenum or Nickel/Iron alloy. Alternatively it may be made of glass, glass fiber, plastics or polymer such as PTFE.

More than one pin may be provided, dependent upon the required thermal characteristics and other features of the bulb.

This pin may be integrally formed with the sintered glass layer, preferably fused in place during manufacture. Alternatively, it may be releasable from the sintered glass later and therefore function as the coupling described herein before. It may be provided with, for example, a universal twist lock.

The pin may be an integral part of the lamp formed during manufacture or may be bonded onto the lamp after manufacture.

The sintered layer may have a uniform thickness or may have a greater thickness closer to the pin than in regions farther from the pin.

The sintered layer is able to absorb a volatile oil. The oil may be supplied with the bulb or may be supplied separately. It is envisaged that a wide range of oils may be supplied which can be purchased separately.

The device may be provided in the form of a range of different shapes and sizes allowing different devices to be used to replace conventional bulbs. For example, the bulb may be a 40 watt, 60 watt, 100 watt or 150 watt bulb as is conventional for domestic lighting applications.

The sintered glass layer and/or the glass casing may be colored. In the arrangement where the layer can be removed, a different effect can then be obtained by attaching layers of different colors or opacities. It is therefore envisaged that a wide range of different sintered layers may be provided.

The layer may be formed into a shroud which substantially surrounds the whole of the casing of the bulb.

Thus, according to a second aspect the invention provides in combination a fragrance-emitting device according to the first aspect and fragranced oil.

According to a third aspect the invention provides a sintered glass carrier for volatile chemicals comprising a layer of sintered glass and adapted to be attachable to a light bulb said layer being so constructed and arranged as to conform to the shape of at least part of a light bulb, the layer including an attachment means adapted to attach said layer to said bulb.

The coupling may comprise an opening having an internal thread suitable for engagement with a corresponding male thread protruding from the bulb. The opening may be formed by a nut which is held captive within the sintered glass, perhaps fused in place.

The sintered glass layer may be colored and may be impregnated with a volatile chemical substance such as oil.

According to a fourth aspect the invention provides a light bulb comprising a fitting adapted to connect said light bulb to a light socket;
a light emitting element and
a casing having a partially transparent region;
said casing surrounding said element and permitting light to pass through at least said partially transparent region; and
said casing being formed of glass and including a connection means adapted to
co-operate with a sintered glass carrier said sintered glass carrier adapted to carry a volatile chemical.

The connector may comprise a pin which extends from the casing of the bulb outwards. It may carry a male thread which is adapted to co-operate with a complimentary thread on a carrier. The thread may comprise a universal twist lock.

According to a fifth aspect the invention provides a vapor delivering device for the evaporation of chemicals by thermal diffusion said device comprising a chemical carrying element;
a retainer adapted to retain said chemical carrying elements;
fixing means adapted to secure said retainer to or in the vicinity of a thermal source; and
said chemical carrying element comprising sintered glass.
   Preferably the chemical carrying element comprises a disc of sintered glass. In a preferred embodiment the disc is formed of sintered glass having an overall porosity of 35% by volume.

The retaining means may comprise a disc holder formed of plastics material. The holder may comprise a first portion adapted to contain the disc of sintered glass and a second portion adapted and arranged to locate over, and secure to the first portion so retaining the disc. The first and second portions may each be provided with one or more apertures.

Preferably the second portion is provided with at least one aperture.

The first and section portions are preferably formed of a thermo-resistant plastic.

The fixing means may comprise a metal pin. The metal pin may be integrally formed with the heat source or may be arranged to engage with the heat source. Alternatively the fixing means may be an adapter with a suitable adhesive between the adapter and the heat source.

In one embodiment the heat source is a conventional electrical bulb. The bulb may be a conventional shape or maybe a candle bulb or even a long life compact fluorescent bulb.

It is also envisaged that the heat source may be a camping gas light or other source of heat.

In an embodiment in which the heat source is a camping gas light, a conventional globe of the gas lamp or a conventional metal cap located above the globe may be replaced with a globe or cap comprising at least part of the chemical carrying element adapted to hold a volatile substance whereby in use heat from the camping gas light heats the volatile substance causing at least some of it to evaporate.

The chemical carrying element may comprise a disk retained within a metal cap for a camping gas light. Other shaped inserts are also envisaged.

Alternatively an insert may be provided in the globe surrounding the gas light.

Retaining means are provided which may allow the disc to be removed and replaced or may allow recharging of the chemical carrying element with the volatile substance.

Fixing means may be provided. These may secure the retainer, combined globe and retainer, or combined cap and retainer, to the thermal source, in this case the camping gas light unit.

In another embodiment suitable retaining means and fixing means are provided to secure the chemical carrying element to or adjacent a fluorescent tube as the thermal source.

According to a sixth aspect the invention provides a chemical carrying element for use in a vapor delivering device according to any previous aspect of the invention.

According to a seventh aspect the invention provides a retaining means suitable for retaining a chemical carrying element said retaining means being adapted to releasably engage with fixing means provided on or fixed to a thermal heat source.

According to an eighth aspect the invention provides a volatile substance suitable for use in a vapor delivering device according to the first to fifth aspects of the invention.

According to a ninth aspect the invention provides a vapor delivering device for the evaporation of chemicals by thermal diffusion said device comprising a thermal source;
a chemical carrying element;
connection means adapted to connect said chemical carrying element to said thermal source; and wherein
said chemical carrying element comprises sintered glass.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is an illustration of a first vapor delivering device in accordance with the first aspect of the present invention;

FIG. 2 is an illustration of a second vapor delivering device in accordance with the first aspect of the present invention;

FIG. 3A is an illustration of a third alternative vapor delivering device in accordance with the first aspect of the invention;

FIG. 3B is an illustration of a fourth alternative vapor delivering device in accordance with the first aspect of the invention;

FIG. 4 is an illustration of a fifth vapor delivering device in accordance with the fifth aspect of the invention;

FIG. 5 is a cross-section along the line A-A of FIG. 4;

FIG. 6 is an illustration of a sixth vapor delivering device in accordance with the fifth aspect of the invention;

FIG. 7 is an exploded view of the device of FIG. 6;

FIG. 8 is a diagrammatic illustration of a conventional camping gas lantern;

FIGS. 9A and 9B are illustrations of a cap for a lantern incorporating a vapor delivering device; and

FIGS. 10A and 10B are illustrations of a globe for a lantern incorporating a vapor delivering device.

### DESCRIPTION

### Figures and Disclosed Embodiments Are Not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein.

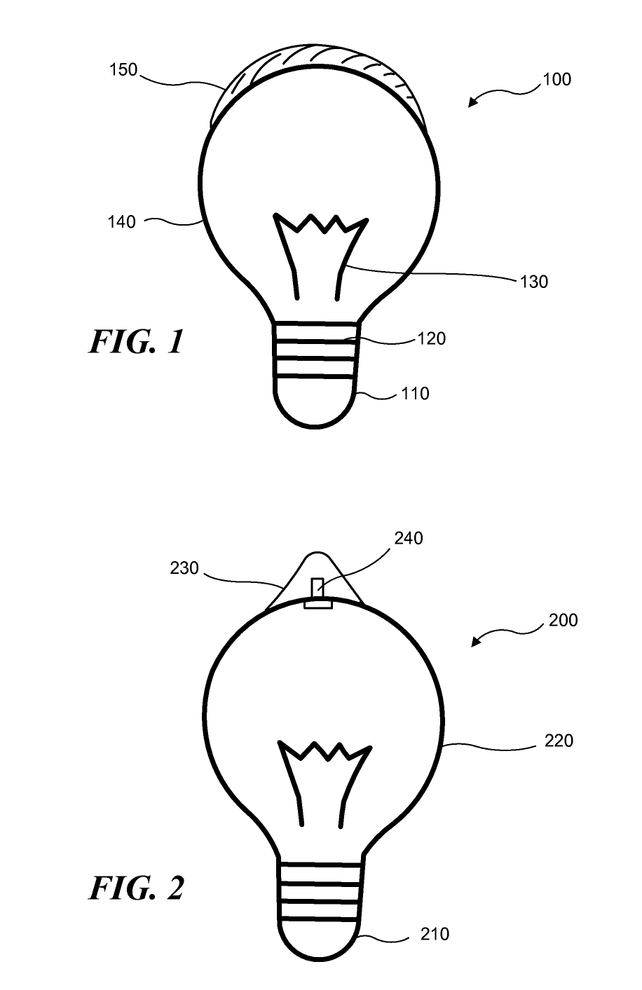

FIG. 1 shows a vapor delivering device 100 which functions as a light bulb. As such it can be used to replace any conventional light bulb around a home or workplace. It comprises a conductive base 110 having a screw thread 120. The base and thread are shaped to co-operate with a light fitting (not shown) having a complimentary thread.

Attached to the base 110 is a light emitting element 130 which in the example shown is a resistive filament. The filament draws current from the supply to the light socket and as current passes through the filament it heats up to such an extent that it emits light. Such technology is well known to the man skilled in the art.

The filament is protected by a glass casing 140 and a suitable gas is sealed within the casing 140 to ensure that the filament operates effectively. The glass casing 140 in the example is totally transparent although it may be opaque. It is dome shaped but could be other shapes as desired without impairing the function of the device.

At the top of the glass casing 140 is a layer of sintered glass 150 which is integrally formed with the casing 140. This sintered glass layer 150 is porous. A volatile fluid (not visible in the figures) is absorbed within the sintered glass layer 150. The fluid is selected to have properties that permit it to evaporate as it is heated by the element. In the example shown the fluid contains a fragrance and as it heats the glass allows the fragrance to pass into the air around the bulb. The fluid may be selected depending on the pore size and the desired use, whether as an air freshener, insect repellent or other use. The fluid may be a volatile oil.

An alternative embodiment of a vapor delivering device 200 is shown in FIG. 2. This device is similar to that of FIG. 1 of the accompanying drawings having a base 210 and casing 220 but in this device a sintered layer 230 is provided which is thicker and is penetrated by a metallic pin 240 which passes through the glass casing. The pin 240 helps to carry heat from the inside of the casing into the sintered glass layer 230. It is envisaged that in at least some arrangements this may permit a thicker layer of sintered glass to be used whilst ensuring it heats through rapidly when the bulb is switched on. The pin 240 also helps secure the sintered glass layer.

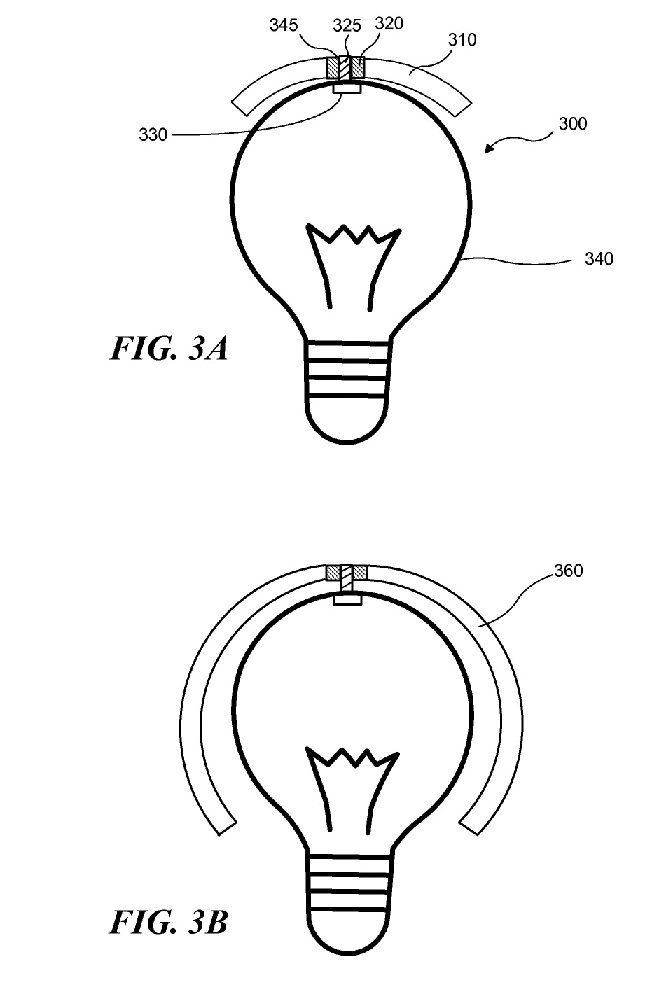

A third alternative arrangement of a vapor delivering device 300 is shown in FIG. 3 of the accompanying drawings. In this arrangement the sintered glass portion comprises a removable carrier 31 0. It includes a captive nut 320 which has an internal female thread 325. A pin 330 is secured to the glass casing 340 of the device in a similar manner to the embodiment of FIG. 2 and carries an external male thread 345 which compliments the female thread of the nut. This arrangement allows the sintered glass carrier to be removed from the glass casing if desired.

FIG. 3B shows a modification to the arrangement of FIG. 3A in which the sintered glass portion comprises a shroud 360 which extends completely around the bulb casing. The shroud 360 is colored to alter the light that is emitted into a room allowing it to be used to create different feelings of personal well being. Alternatively it may be used as a night light. The volatile liquid may be a decongestant if desired.

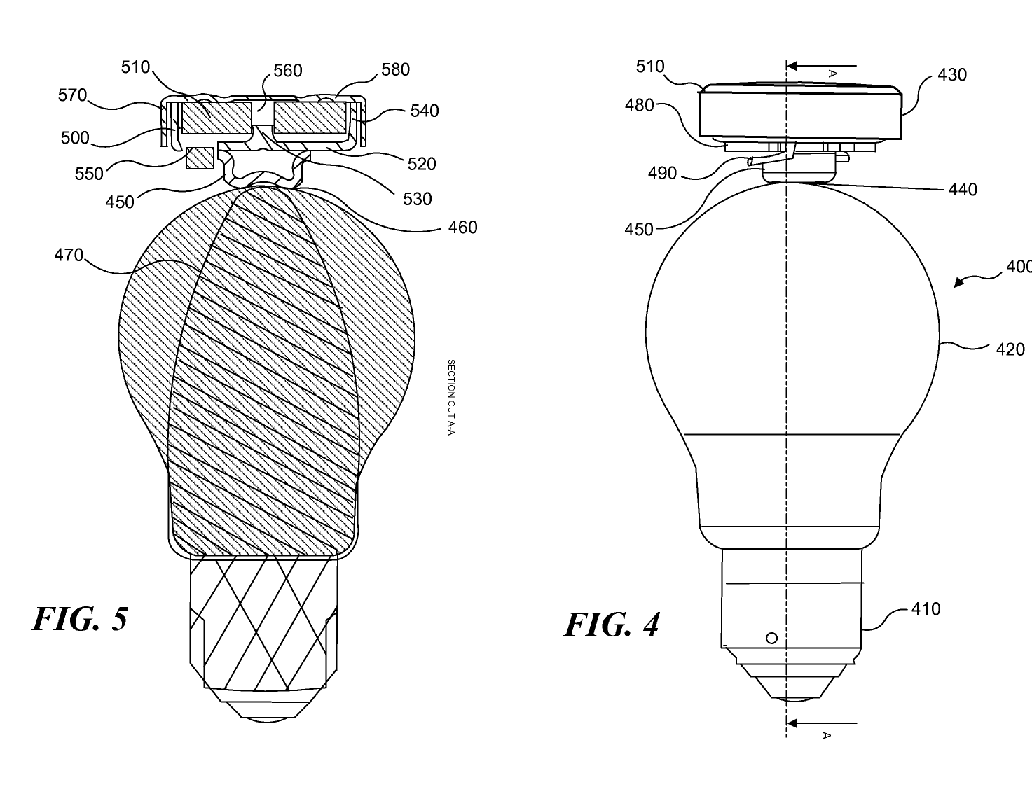

FIG. 4 shows an alternative embodiment of a vapor delivering device 400. The device comprises a conventional light bulb 40 having a base 410 and a casing 420. In this embodiment the light bulb is a thermal source of radiant heat as well as a source of light.

A retainer 430 is located at an end of the light bulb remote from the base 410. The retainer 430 is secured to the casing 420 of the light bulb by suitable means, in this case adhesive 440 and an adapter 450. The adhesive should be suitable for use in situations reaching a high temperature and also able to sustain wide temperature fluctuations.

LOCTITE 350 (RTM) supplied by Henkel Technologies and RTV 382 supplied by Intek Adhesives have been found to be suitable adhesives.

The adapter 450 is shaped to abut with a conventional light bulb. A lower surface 460 of the adapter is shaped to be able to abuttingly engage the light bulb and adhesive is applied to the lower surface 460 to secure the adapter to the casing 420 of the light bulb.

Preferably the lower surface 460 of the adapter is shaped such that the same adapter can be used on more than one form of conventional light bulb—in FIG. 5 a candle light bulb 470 is also shown and as can be seen the lower surface 460 can abuttingly engage an end of this form of light bulb too.

The adapter 450 is also provided with lugs 480 arranged to cooperate and engage lugs on the retaining means. Other releasable engaging means could be used.

The retaining means comprises a first portion 500 arranged to contain a disc 510 of sintered glass. The first portion 500 comprises a base 520 having a central locating pin 530, side walls 540 and apertures 550 on the base 520. Portions of the base 520 may be pressed out in manufacture to form the apertures 550 and lugs 490 which engage with cooperating lugs 480 on the adapter.

In this embodiment the chemical carrying element comprises a disc 510 of sintered glass. The disc 510 has a central aperture 560 arranged to locate over the locating pin 530 of the first portion of the retaining means. Alternative shapes may be used.

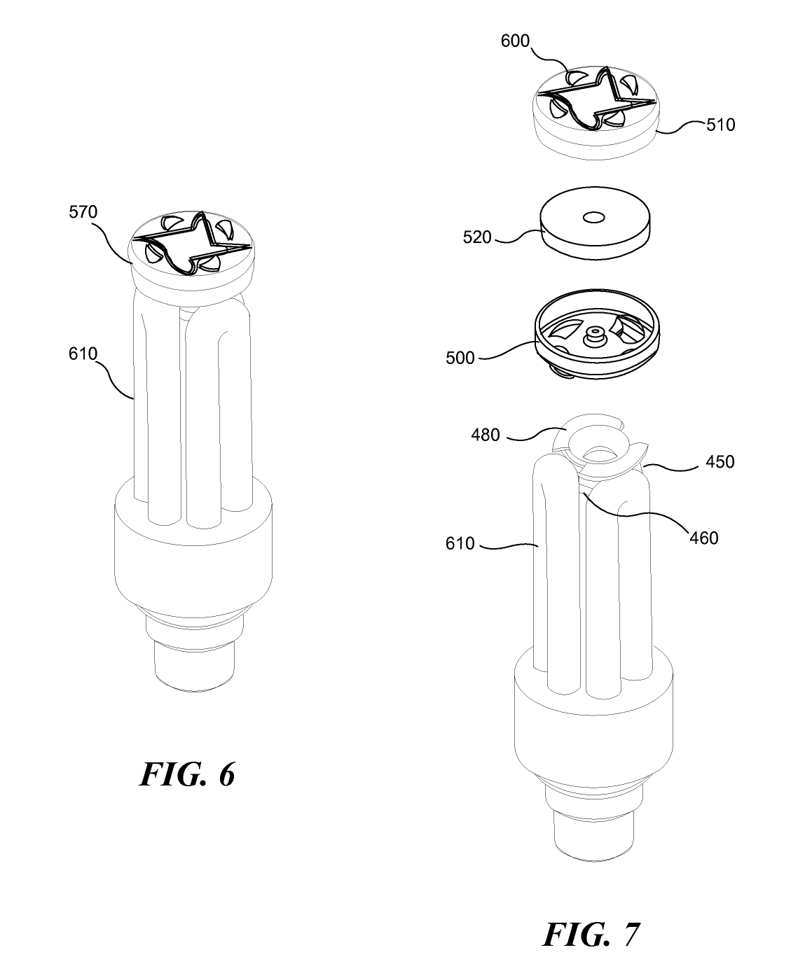

The retaining means further comprises a second portion 570 arranged to securely but removably locate over the first portion 500. The second portion 570 comprises a cover 580, arranged in use to be parallel to the base 520, and side walls 590 extending in use from the cover 580 towards the first section 500. The cover 580 is provided with a number of apertures. These may be seen in FIGS. 6 and 7. The apertures 600 allow passage of the volatile substance from the carrying element, disc 510, into the atmosphere when heated.

The side walls 570 of the second portion are arranged to releasably engage with the side walls 540 of the first portion. They may for example be a push fit.

The first and second portions together with the adapter may be made of a suitable plastics material. A suitable plastics material should have good mechanical qualities, be chemically resistant to the chosen vapors and be heat resistant. Suitable plastics materials include Zytel® nylon, RYNITE® and CRASTIN® all supplied by DuPont. It will be understood that other plastics having suitable properties may be substituted, or other non-plastic materials having suitable properties could be used.

Turning to FIGS. 6 and 7 these show a retaining means and adapter arranged to fix the vapor delivering device to an energy saving bulb of the compact fluorescent type. As can be seen the retaining means is very similar to that of FIGS. 4 and 5. The adapter 450 is arranged such that the lower surface 460 is able to fit within the tubes 610 of the light bulb.

Alternative adapters could be utilized. Further variations are envisaged in order to fix the retaining means to other types of light bulbs.

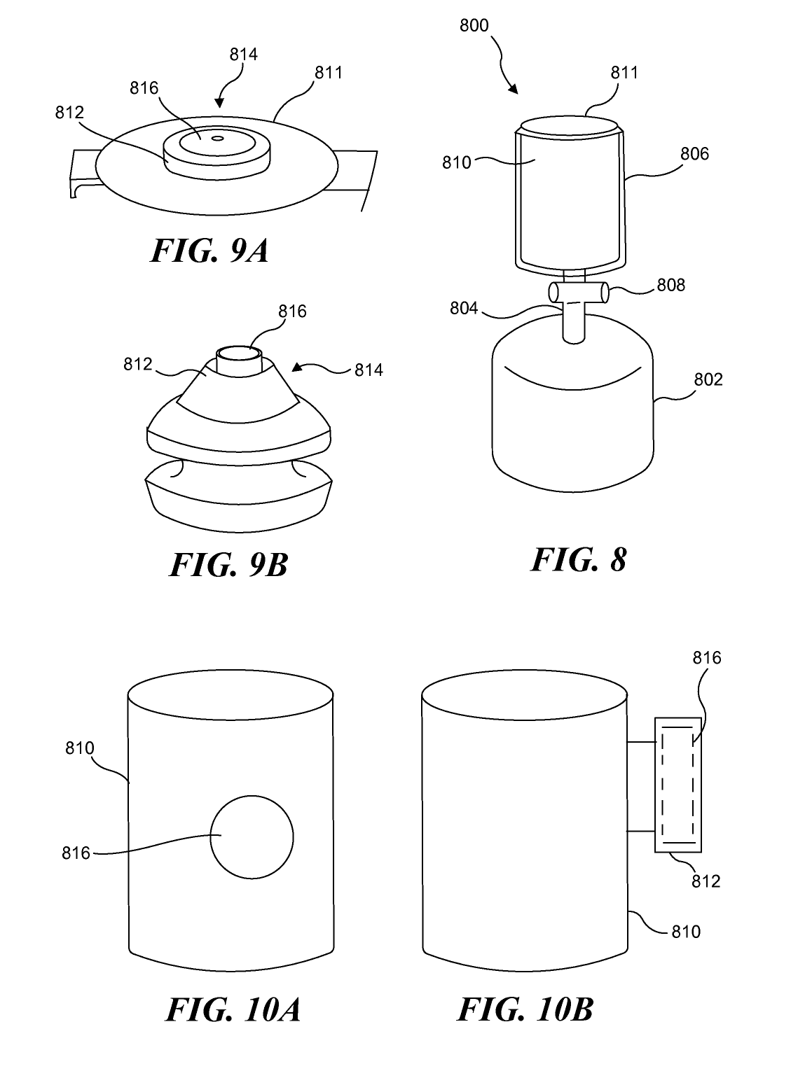

Turning now to FIGS. 8 to 10, FIG. 8 shows a conventional camping gas lamp 800 having a source of gas 802, a pipe 804 delivering gas to a lamp portion 806. A means of controlling delivery of the gas is provided by a valve 808.

The lamp portion 806 comprises a globe 810 conveniently formed of glass, either opaque or clear, and a cap 811. This cap 811 is conventionally made of metal.

Means, not shown, are provided for securing the cap in place over the globe 810. Commonly hanging means are also provided whereby the lamp can be suspended.

FIG. 9A shows an embodiment of the invention in which a retaining means 812 is provided secured to the cap 811. The retaining means may be similar or identical to that used for the light bulbs or an alternative form may be used. A fixing means may be provided to fix the retainer 812 to the cap 811. The fixing means may comprise an adapter and adhesive as before or may be different.

Alternatively, as shown in FIG. 9B, retaining means may be formed integrally in the metal cap. The retainer may contain a chemical carrying element 814 in the form of sintered glass in a disc 816.

A further alternative comprises providing retaining means 812 and fixing means suitable for affixing to a portion of the globe 810, as generally indicated in FIG. 10B. It may be desirable to use a glass retaining means.

The chemical carrying element may be formed integrally with the globe as generally indicated in FIG. 10A. Alternatively the retaining means may be integral with the globe 810 and the disc 816 may be removable.

A man skilled in the art may adapt variations in the fixing and/or retaining means without departing from the invention.

A number of materials have been investigated for their suitability as the chemical carrying element. Of these sintered glass has been found to be particularly effective. The sintered glass provides suitable retention of volatile substances. Other materials may also be suitable. Micro or nanoporous materials may have suitable properties.

Sintered glass having an overall porosity of around 35% by volume may be formed from a thermal, shock-resistant borosilicate glass such as Pyrex or Duran.

Preferably the particle size is substantially homogeneous with a particle size distribution range of the particles from 40-80 microns. Particles between 0.1 and 100μ may be used depending on the properties of the volatile substance.

Preferably both larger and finer sinters are not incorporated. It is believed that a homogenous distribution of particle size may facilitate the retention of volatile substances in use and so prolong the working life of a charged element.

In a form of the invention the glass sinters have pore diameters of 7-20 microns. The pore size may be much smaller, for example 10⁻⁹ m to 10⁻³ m.

It is envisaged that the pore size of the chemical carrying element may be varied depending on surface tension and wetting properties of the volatile substance. The pore size may be less than 0.1 microns or greater than 100 microns. Nanoporous materials may also be particularly suitable for use as the chemical carrying element.

Preferably the material of the chemical carrying element is non reactive with the volatile substance.

The applicant has realized that a vapor delivering device may be provided for evaporation of chemicals into the atmosphere by thermal diffusion comprising a chemical carrying element in combination with (secured to or integrated with) a thermal heat source, the chemical carrying element being adapted to release a chemical over a period of time under the influence of heat from the thermal heat source.

Alternatively a vapor delivering device may be provided for evaporation of chemicals into the atmosphere by thermal diffusion comprising a chemical carrying element and fixing means adapted to fix the chemical carrying means on or in the vicinity of a thermal heat source, the chemical carrying element being adapted to release a chemical over a period of time under the influence of heat from the thermal heat source.

The thermal heat source may be a hand drier. The chemical carrying element may be secured to the hand drier or in the vicinity of the hand drier.

Preferably the chemical carrying element is one of sintered glass, a microporous material or a nanoporous material.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A vapor delivering device for the evaporation of chemicals into the atmosphere by thermal diffusion, the device comprising a light bulb having a fitting suitable for connection to a light socket, said light bulb comprising:
(a) a light emitting element; and
(b) a casing, said casing having a portion that is partially transparent, said casing surrounding said light emitting element to permit light to pass through said partially transparent portion, said casing being made of glass and including at least one region of sintered glass, said sintered glass region being adapted to hold a volatile substance, whereby in use said light emitting element emits heat which heats said sintered glass region causing at least some of the substance to evaporate.

2. The vapor delivering device of claim 1 wherein said region of sintered glass is integrally formed with said glass casing.

3. The vapor delivering device of claim 2 wherein said sintered glass region is fused to said casing.

4. The vapor delivering device of claim 2 wherein said sintered glass region is bonded to said casing.

5. The vapor delivering device of claim 1 wherein said casing is provided with a coupling means and said sintered glass region comprises a layer of sintered glass provided with connecting means adapted to connect said sintered glass layer to said coupling means.

6. The vapor delivering device of claim 5 wherein said coupling means comprises a pin having a first end secured to said casing and a second end having a thread and said connecting means comprises a complimentary thread provided on said sintered glass layer.

7. The vapor delivering device of claim 5 wherein said layer is pre-shaped to compliment a shape of said casing.

8. The vapor delivering device of claim 1 wherein said region of sintered glass is remote from said fitting.

9. The vapor delivering device of claim 1 wherein said region of sintered glass has a uniform thickness.

10. A sintered glass carrier for volatile chemicals comprising a layer of sintered glass and adapted to be attachable to a light bulb, said layer being so constructed and arranged as to conform to a shape of at least a part of said light bulb, said layer including an attachment means adapted to attach said layer to said bulb.

11. A light bulb comprising:
(a) a fitting adapted to connect said light bulb to a light socket;
(b) a light emitting element; and
(c) a casing having a partially transparent region; said casing surrounding said element and permitting light to pass through at least said partially transparent region, said casing being formed of glass and including a connection means adapted to co-operate with a sintered glass carrier, said sintered glass carrier being adapted to carry a volatile chemical.

12. A vapor delivering device for the evaporation of chemicals by thermal diffusion, said device comprising:
(a) a chemical carrying element;
(b) a retainer adapted to retain said chemical carrying elements; and
(c) fixing means adapted to secure said retainer to or in the vicinity of a thermal source, said chemical carrying element comprising sintered glass.

13. The vapor delivering device of claim 12 wherein said chemical carrying element comprises a sintered glass disc.

14. The vapor delivering device of claim 13 wherein said sintered glass disc has an overall porosity of 35% by volume.

15. The vapor delivering device of claim 12 wherein said retainer comprises a disc holder formed of a plastics material.

16. The vapor delivering device of claim 15 wherein said retainer comprises a first portion adapted to contain said disc and a second portion adapted to locate over and secure to said first portion, said disc being retained between said first and second portions.

17. The vapor delivering device of claim 16 wherein said first and second portions are each provided with one or more apertures.

18. The vapor delivering device of claim 16 wherein said first and second portions are formed of thermo-resistant plastics.

19. The vapor delivering device of claim 12 wherein said fixing means comprises a metal pin.

20. The vapor delivering device of claim 12 wherein said thermal source is a conventional light bulb.

21. The vapor delivering device of claim 12 wherein said thermal source is a camping gas lamp.

22. A retaining means suitable for retaining a chemical carrying element, said retaining means being adapted to releasably engage with fixing means provided on or fixed to a thermal heat source.

23. The retaining means of claim 22 in which said retaining means comprises:
(a) a first portion adapted to locate and contain said chemical carrying means; and
(b) a second portion adapted to removably locate over said first portion.

24. A vapor delivering device for the evaporation of chemicals by thermal diffusion, said device comprising:
(a) a thermal source;
(b) a chemical carrying element; and
(c) connection means adapted to connect said chemical carrying element to said thermal source; and wherein said chemical carrying element comprise sintered glass.

25. The vapor delivering device of claim 24 wherein said sintered glass has an overall porosity of around 35% by volume.

26. The vapor delivering device of claim 24 wherein the sintered glass is a thermal shock resistant borosilicate glass.

27. The vapor delivering device of claim 24 wherein the sintered glass comprises substantially homogenous particles, said particles having a size distribution range from 01 to 100 microns.

28. The vapor delivering device of claim 27 wherein the sintered glass comprises substantially homogenous particles, said particles having a size distribution range from 40-80 microns.

29. The vapor delivering device of claim 24 wherein said sintered glass comprises particles having a pore size in the range 0.1 to 100 microns.

30. The vapor delivering device of claim 24 wherein said sintered glass comprises particles having a pore size in the range 7-20 microns.
